(19) United States
(12) Patent Application Publication
(10) Pub. No.: US 2026/0136085 A1
(43) Pub. Date: May 14, 2026

(54) MEASUREMENT DEVICE AND MEASUREMENT METHOD

(71) Applicant: HAMAMATSU PHOTONICS K.K., Hamamatsu-shi, Shizuoka (JP)

(72) Inventor: Tomonori NAKAMURA, Hamamatsu-shi, Shizuoka (JP)

(73) Assignee: HAMAMATSU PHOTONICS K.K., Hamamatsu-shi, Shizuoka (JP)

(21) Appl. No.: 18/706,077

(22) PCT Filed: Oct. 12, 2022
(86) PCT No.: PCT/JP2022/038103

§ 371 Date: Apr. 30, 2024

(30) Foreign Application Priority Data
Dec. 15, 2021 (JP) 2021-203423

(51) Int. Cl. H04N 23/56; G01P 3/38; G06T 7/292

(52) U.S. Cl. CPC H04N 23/56; G01P 3/38; G06T 7/292; G06T 2207/10152

(57) ABSTRACT

A high-speed object measurement apparatus includes a light irradiation unit configured to irradiate a moving object with light whose wavelength changes with time, an image capturing unit configured to capture an image of light from the object that has received light emitted by the light irradiation unit and acquire wavelength information for each pixel, in which the image capturing unit continuously acquires a temporal change of a wavelength.

### TECHNICAL FIELD

One aspect of the present invention relates to a measurement apparatus and a measurement method.

### BACKGROUND ART

Cited Literature 1 describes a high-speed imaging method that enables continuous imaging of a single phenomenon that changes in an ultra-short time region of nanoseconds or less. Specifically, there is described a high-speed imaging system that continuously irradiates an object with a plurality of strobe lights having different wavelengths, spatially separates light from the object (a plurality of light beams having different wavelengths) for each wavelength while holding image information, and causes the separated light to enter different positions on a light receiving surface of an imaging element to detect the light. According to such a high-speed imaging system, a dynamic phenomenon is measured on the basis of image information of each detected light (each wavelength).

### CITATION LIST

### Patent Literature

Patent Literature 1: Japanese Unexamined Patent Publication No. 2015-41784

### SUMMARY OF INVENTION

### Technical Problem

Here, in the high-speed imaging system as described above, a plurality of light beams having different wavelengths from the object are spatially separated for each wavelength. In the case of using the method of separating light in this manner, measurement of a dynamic phenomenon based on image information of each detected light (each wavelength) is not continuous but discrete. As a result, there is a possibility that the dynamic phenomenon of the object cannot be measured with high accuracy.

One aspect of the present invention has been made in view of the above circumstances, and an object thereof is to measure a dynamic phenomenon of an object with high accuracy.

### Solution to Problem

A measurement apparatus according to one aspect of the present invention includes a light irradiation unit configured to irradiate a moving object with light whose wavelength changes with time, an imaging unit configured to capture an image of light from the object that has received light emitted by the light irradiation unit and acquire wavelength information for each pixel, in which the imaging unit continuously acquires a temporal change of a wavelength.

In the measurement apparatus according to one aspect of the present invention, light whose wavelength changes with time irradiates a moving object, light from the object is imaged, and wavelength information is acquired for each pixel. Then, in the measurement apparatus, with respect to the light whose wavelength changes with time, the wavelength information is directly acquired for each pixel without being detected after being spatially separated, for example, and thus, the temporal wavelength change is continuously acquired without being discrete. As a result, it is possible to estimate at which timing and at which position the object has been, with high accuracy, on the basis of the change in the acquired wavelength information. As described above, according to the measurement apparatus according to one aspect of the present invention, the dynamic phenomenon of an object can be measured with high accuracy.

Note that, also in the method of spatially separating the light whose wavelength changes with time and causing the separated light to enter different positions on the light receiving surface of the imaging unit, for example, it is conceivable to prevent the temporal wavelength change from being discrete as much as possible by finely separating time (that is, wavelength). However, in such a method, as the time is more finely separated, the light receiving area of the imaging unit is more required, and thus, there are problems that the number of frames is limited and then the visual field is narrowed, and the number of pixels of the image is reduced. That is, there is a trade-off relationship between increasing the temporal separation number to measure the dynamic phenomenon of the object with high accuracy and decreasing the light receiving area, and it has been conventionally difficult to achieve both. In this regard, as described above, according to the measurement apparatus according to one aspect of the present invention, the light whose wavelength changes with time is not spatially separated and detected, but the wavelength information is directly detected for each pixel. Therefore, it is possible to measure the dynamic phenomenon of the object with high accuracy without causing the problem due to the light receiving area described above.

The light irradiation unit may emit light whose wavelength changes in a cycle of one cycle or more within an exposure time of the imaging unit. According to such a configuration, it is possible to measure (store) the dynamic phenomenon of the object with the time width of the light whose wavelength changes with time in one frame of the imaging unit.

The light irradiation unit may be arranged such that an optical axis of light directed from the light irradiation unit toward the object and an optical axis of light directed from the object toward the imaging unit are orthogonal to each other. According to such a configuration, for example, in a case where the object moves in the same direction as the optical axis direction of the light directed from the light irradiation unit toward the object, a certain point (for example, an edge portion) of the object is irradiated with light, and the change in wavelength with the lapse of time of the light from the certain point can be detected by pixels mutually different in the imaging unit. That is, it is possible to measure the dynamic phenomenon of the object with high accuracy based on the detection result of each pixel while avoiding light from entering the same pixel a plurality of times.

The light irradiation unit may be arranged such that an optical axis of light directed from the light irradiation unit toward the object and an optical axis of light directed from the object toward the imaging unit obliquely intersect with each other, the measurement apparatus may further include a slit arranged on an optical axis of light traveling from the object toward the imaging unit, and the slit may change a region through which light passes according to a lapse of time. In a case where the above-described two optical axes obliquely intersect with each other, when the surface of the moving object is irradiated with light, light at a plurality of timings may enter the same pixel. In this respect, the slit is arranged on the optical axis of the light directed from the object toward the imaging unit, and the region through which the slit passes the light is changed according to the lapse of time, so that it is possible to avoid the light at a plurality of timings from entering the same pixel, and it is possible to measure the dynamic phenomenon of the object with high accuracy even in a case where the surface of the moving object is irradiated with the light.

The light irradiation unit may include a first irradiation unit configured to emit light in a first wavelength range whose wavelength changes in a cycle as a first cycle, and a second irradiation unit configured to emit light in a second wavelength range different from the first wavelength range whose wavelength changes in a cycle as a second cycle different from the first cycle. As described above, by irradiating the object with light having different wavelength ranges with different cycles in which the wavelengths change from each other, a position at which the object has been is estimated from the information on the wavelengths of the two light beams, therefore, it is possible to improve the time resolution and measure the dynamic phenomenon of the object with higher accuracy as compared with the case of estimating from only one light beam.

The imaging unit may include a first camera configured to capture an image of light from an object that has received light emitted by the first irradiation unit, and a second camera configured to captures an image of light from an object that has received light emitted by the second irradiation unit. According to such a configuration, the above-described information on the wavelengths of the two light beams is captured by the two cameras, and an image based on changes in the wavelengths of the two light beams can be appropriately generated. As a result, the dynamic phenomenon of the object can be measured with high accuracy.

The light irradiation unit may include a white light source, and may change a wavelength with time by optically selecting a wavelength of white light. According to such a configuration, light whose wavelength changes with time can be generated with a simple configuration.

The light irradiation unit may include a pulsed light source, and may change a wavelength with time by wavelength-dispersing pulsed light. According to such a configuration, light whose wavelength changes with time can be generated with a simple configuration.

The imaging unit may include a separation optical element that separates light from the object by transmitting or reflecting the light according to a wavelength, having an edge transition width with a predetermined width, which is a width of a wavelength band in which transmittance and reflectance change according to a change in wavelength, and may image light transmitted through the separation optical element in a first imaging region and light reflected by the separation optical element in a second imaging region. According to such a configuration, each of the light beams separated by the separation optical element whose transmittance and reflectance change according to the change in wavelength is imaged, and the wavelength can be appropriately detected on the basis of the respective imaging results.

A measurement method according to one aspect of the present invention includes the steps of irradiating a moving object with light whose wavelength changes with time, and capturing an image of light from the object receiving light and acquiring wavelength information for each pixel, in which the step of acquiring wavelength information continuously acquires a temporal change of a wavelength.

### Advantageous Effects of Invention

According to the measurement apparatus and the measurement method according to one aspect of the present invention, the dynamic phenomenon of an object can be measured with high accuracy.

### BRIEF DESCRIPTION OF DRAWINGS

FIG. 1 is a diagram schematically illustrating a high-speed object measurement apparatus according to an embodiment of the present invention.

FIG. 2 is a diagram schematically illustrating an example of a light irradiation unit included in a camera system of the high-speed object measurement apparatus in FIG. 1.

FIG. 3 is a diagram schematically illustrating an example of an image capturing unit included in the camera system of the high-speed object measurement apparatus in FIG. 1.

FIG. 4 is a diagram for explaining a characteristic of an inclined dichroic mirror.

FIG. 5 is a diagram illustrating an example of a captured image.

FIG. 6 is a diagram schematically illustrating a camera system of the high-speed object measurement apparatus according to a first modification.

FIG. 7 is a diagram schematically illustrating a camera system of the high-speed object measurement apparatus according to a second modification.

FIG. 8 is a diagram schematically illustrating a slit included in the camera system of FIG. 7.

FIG. 9 is a diagram schematically illustrating a camera system of the high-speed object measurement apparatus according to a third modification.

### DESCRIPTION OF EMBODIMENTS

Hereinafter, embodiments of the present invention will be described in detail with reference to the drawings. The same or corresponding parts in the respective drawings are denoted with the same reference signs, and repetitive descriptions will be omitted.

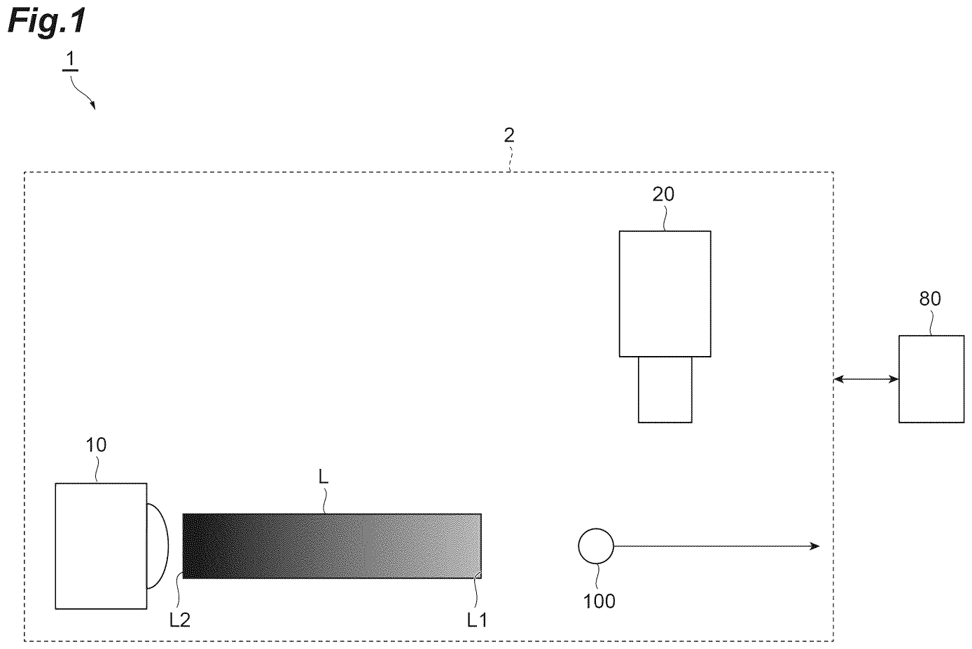

FIG. 1 is a diagram schematically illustrating a high-speed object measurement apparatus 1 according to the present embodiment. The high-speed object measurement apparatus 1 is an apparatus that irradiates an object 100, which is an object moving at a high speed, with light whose wavelength changes with time, and captures an image of light from the object 100, thereby recording movement of the object 100 on a two-dimensional image to measure a dynamic phenomenon of the object 100. That is, in the high-speed object measurement apparatus 1, since the time and the wavelength are associated with each other with respect to the emitted light, when the light from the object 100 is imaged and the wavelength is specified, it is possible to estimate at which timing and at which position the object 100 has been, and to measure the dynamic phenomenon of the object 100. The object 100 is, for example, a flying object or a fragment, and the dynamic phenomenon of the object 100 may be, for example, a phenomenon in which the flying object passes or recoil, a phenomenon in which a plurality of fragments scatter, or the like.

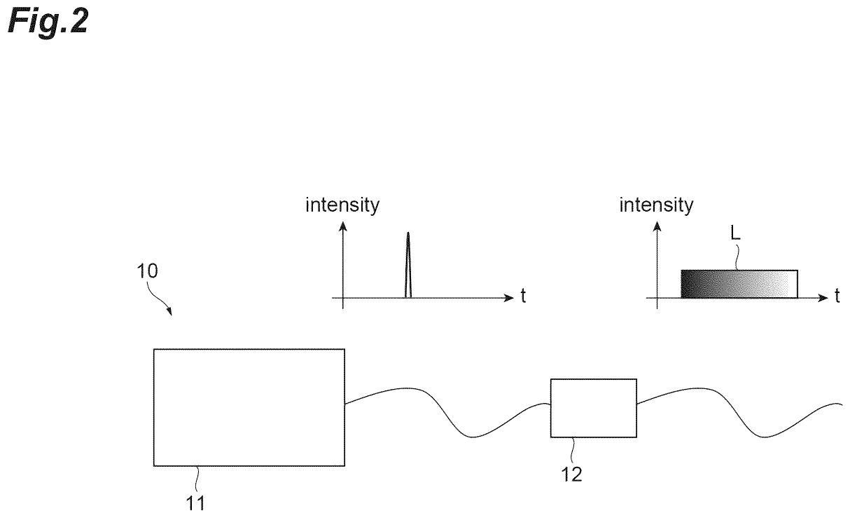

As illustrated in FIG. 1, the high-speed object measurement apparatus 1 includes a camera system 2 and a control apparatus 80. The camera system 2 includes a light irradiation unit 10 and an image capturing unit 20 (imaging unit). Details of the camera system 2 will be described with reference to FIGS. 2 to 4.

The light irradiation unit 10 is configured to irradiate the moving object 100 with light whose wavelength changes (wavelength sweep) with time. In FIG. 1, a temporal change in wavelength of the light L emitted from the light irradiation unit 10 is illustrated as a color difference. In the example of FIG. 1, one cycle in which the wavelength of the light L changes is illustrated, the first wavelength L1 of one cycle is the shortest, the wavelength gradually becomes longer, and the last wavelength L2 of one cycle is the longest. As an example, the light irradiation unit 10 emits light in a wavelength range of 600 nm to 700 nm, but is not limited thereto, and may emit light in an arbitrary wavelength range included in the wavelength range of visible light (380 nm to 780 nm), for example.

The light irradiation unit 10 is arranged, as illustrated in FIG. 1, such that an optical axis of light directed from the light irradiation unit 10 toward the object 100 (a first optical axis) and an optical axis of light directed from the object 100 toward the image capturing unit 20 (a second optical axis) are orthogonal to each other. The direction of the first optical axis substantially coincides with the direction in which the object 100 moves. The above-described state where the first optical axis and the second optical axis are orthogonal to each other is a state where the first optical axis and the second optical axis may be orthogonal to each other at any timing while the moving object 100 is irradiated with light. For example, the light irradiation unit 10 may cause the image capturing unit 20 to start exposure in synchronization with light whose wavelength changes with time by continuously scanning the object 100 with light and triggering the image capturing unit 20 at a specific timing at the time of scanning. Alternatively, the light irradiation unit 10 may start scanning of light whose wavelength changes with time in synchronization with exposure of the image capturing unit 20 by receiving a trigger from the image capturing unit 20. The light irradiation unit 10 emits light whose wavelength changes in a cycle of one cycle or more within an exposure time of the image capturing unit 20.

FIG. 2 is a diagram schematically illustrating an example of the light irradiation unit 10 included in the camera system 2. As illustrated in FIG. 2, the light irradiation unit 10 may include, for example, a pulsed light source 11 and a dispersion compensation module 12. The pulsed light source 11 is, for example, a femtosecond laser light source. Since the femtosecond laser has a wavelength width of several hundred nm, the pulsed light source 11 can be used for a configuration of a wavelength scanning light source having a time width of more than 200 ns.

The dispersion compensation module 12 extends the broadband pulsed light emitted from the pulsed light source 11 and provides delays (differences in arrival time) different for each wavelength. The dispersion compensation module 12 includes, for example, a highly dispersed fiber, and changes the wavelength with time by wavelength-dispersing the pulsed light. For example, in the case of a single mode fiber, a delay for each wavelength of about 17 ps/nm is generated per 1 km. As a highly dispersed fiber that compensates for the delay, a fiber for 100 km is also generally distributed, and in this case, a delay of about 1700 ps/nm can be generated.

In the two graphs illustrated in FIG. 2, the left side illustrates the state of the pulsed light emitted from the pulsed light source 11, and the right side illustrates the state of the light passing through the dispersion compensation module 12. In the two graphs illustrated in FIG. 2, the horizontal axis represents time, and the vertical axis represents luminous intensity. In the right diagram of FIG. 2, the temporal change in wavelength of the light L is illustrated as a color difference. As illustrated in the right diagram of FIG. 2, the light emitted from the pulsed light source 11 passes through the dispersion compensation module 12, so that the light has a time width and different delays are provided for each wavelength. That is, the light having passed through the dispersion compensation module 12 is light whose wavelength changes with time. Note that high brightness pulsed light of only picoseconds may be converted into light having a wavelength width by a nonlinear effect, and the converted light may be input to the dispersion compensation module 12 to obtain light whose wavelength changes with time.

The configuration of the light irradiation unit 10 that emits light whose wavelength changes with time is not limited to the configuration illustrated in FIG. 2. For example, the light irradiation unit 10 may include a white light source and a plurality of band pass filters arranged spatially continuously. In such a light irradiation unit 10, the wavelength of the white light is optically selected by moving and switching the plurality of bandpass filters, and light whose wavelength changes with time is obtained. Furthermore, the light irradiation unit 10 may include a white light source and a single band pass filter. In such a light irradiation unit 10, the wavelength of the white light is optically selected by rotating the single bandpass filter, and light whose wavelength changes with time is obtained. Furthermore, the light irradiation unit 10 may include a plurality of light irradiation units in which wavelengths of emitted light are different from each other. In such a light irradiation unit 10, a plurality of light irradiation units is temporally switched to obtain light whose wavelength changes with time. In a case where the object 100 has a constant reflectance in the range of the observation wavelength, a plurality of light irradiation units having different wavelengths may simultaneously emit light and continuously change the ratio of the light amounts to obtain light having a wavelength changing with time. Furthermore, the light irradiation unit 10 may include a white light source and a diaphragm.

Returning to FIG. 1, the image capturing unit 20 is configured to image light from the object 100 that has received the light emitted by the light irradiation unit 10 and acquire wavelength information for each pixel. The image capturing unit 20 has a configuration capable of acquiring wavelength information for each pixel in addition to normal image information. The image capturing unit 20 continuously acquires a temporal change in wavelength.

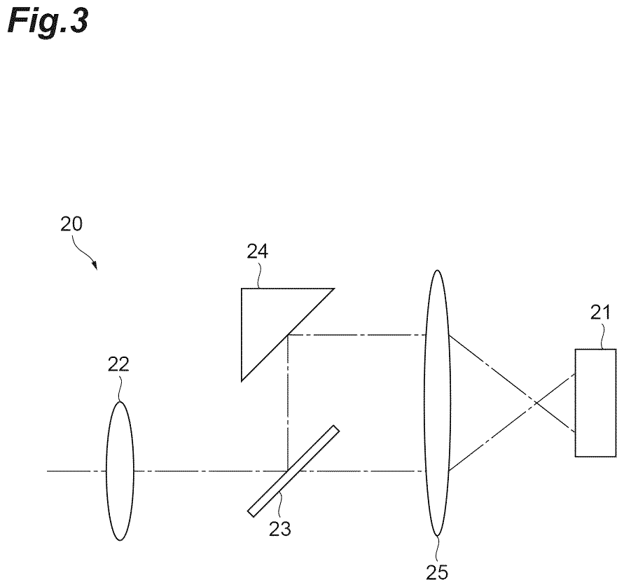

FIG. 3 is a diagram schematically illustrating the image capturing unit 20 included in the camera system 2. As illustrated in FIG. 3, the image capturing unit 20 includes an imaging element 21, an infinity correction lens 22, an inclined dichroic mirror 23 (separation optical element), a total reflection mirror 24, and an image forming lens 25.

The infinity correction lens 22 is a collimator lens that converts light from the object 100 into parallel light. The infinity correction lens 22 is aberration corrected so as to obtain parallel light. Light output from the infinity correction lens 22 is incident on the inclined dichroic mirror 23.

The inclined dichroic mirror 23 is a mirror created using a special optical material, and separates light from the object 100 by transmitting and reflecting the light according to the wavelength. The inclined dichroic mirror 23 reflects light of a specific wavelength and transmits light of other wavelengths, for example.

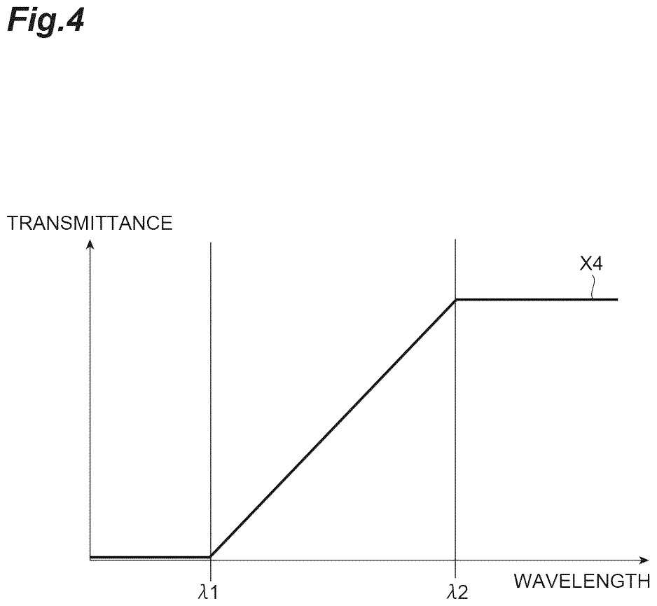

FIG. 4 is a diagram for explaining a characteristic of the inclined dichroic mirror 23. In FIG. 4, the horizontal axis represents wavelength, and the vertical axis represents transmittance. As indicated by the characteristic X4 of the inclined dichroic mirror 23 in FIG. 4, in the inclined dichroic mirror 23, the transmittance (and reflectance) of light gently changes according to a change in wavelength in a specific wavelength band (wavelength band of wavelengths λ₁ to λ₂), and the transmittance (and reflectance) of light is constant regardless of the change in wavelength in a wavelength band other than the specific wavelength band (that is, on the lower wavelength side than the wavelength λ₁ and on the higher wavelength side than the wavelength 22). The transmittance and the reflectance have a negative correlation such that when one is changed in a direction in which the other is increased, the other is changed in a direction in which the other is decreased. Therefore, hereinafter, the transmittance and the reflectance may be simply described as “transmittance” instead of “transmittance (and reflectance)”. Note that “the transmittance of light is constant regardless of a change in wavelength” includes not only a case where the transmittance is completely constant but also a case where a change in transmittance with respect to a change in wavelength of 1 nm is 0.1% or less, for example. On the lower wavelength side than the wavelength λ₁, the transmittance of light is approximately 0% regardless of a change in wavelength, and on the higher wavelength side than the wavelength λ₂, the transmittance of light is approximately 100% regardless of a change in wavelength. Note that “the light transmittance is approximately 0%” includes a transmittance of about 0%+10%, and “the light transmittance is approximately 100%” includes a transmittance of about 100%-10%. In addition, hereinafter, the width of the wavelength band in which the transmittance of light changes according to the change in wavelength may be described as an “edge transition width”. As described above, the inclined dichroic mirror 23 is a separation optical element in which an edge transition width, which is a width of a wavelength band in which transmittance changes according to a change in wavelength, has a predetermined width (widths of wavelengths λ₁ to λ₂).

The total reflection mirror 24 is an optical element that reflects the light reflected by the inclined dichroic mirror 23 in the direction toward the image forming lens 25.

The image forming lens 25 forms an image of the light transmitted through the inclined dichroic mirror 23 and the light reflected by the inclined dichroic mirror 23 and further reflected by the total reflection mirror 24, and guides these light beams to the imaging element 21.

The imaging element 21 images the light transmitted through the inclined dichroic mirror 23 in a first imaging region, and images the light reflected by the inclined dichroic mirror 23 and further reflected by the total reflection mirror 24 in a second imaging region different from the first imaging region. The imaging element 21 detects an image formed by the image forming lens 25 to image light transmitted through the inclined dichroic mirror 23 and light reflected by the total reflection mirror 24. The imaging element 21 is an imaging element for imaging light in a predetermined wavelength range, and is, for example, an area image sensor such as a CCD or a MOS. Furthermore, the imaging element 21 may include a line sensor or a time delay integration (TDI) sensor. In the present embodiment, the imaging element 21 is described as a single imaging element including the first imaging region and the second imaging region, but the imaging element according to the first imaging region and the imaging element according to the second imaging region may be provided separately (two sets may be provided). In this case, two sets of image forming lenses are provided corresponding to the imaging elements. The imaging element 21 outputs an image as an imaging result to the control apparatus 80.

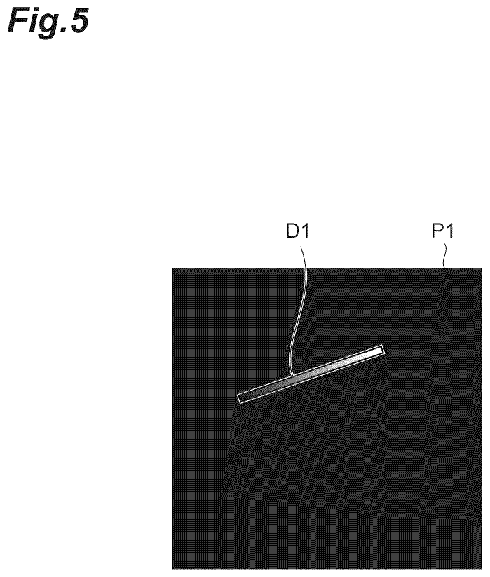

FIG. 5 is a diagram illustrating an example of a captured image P1. An image DI of the dynamic phenomenon of the object 100 is illustrated in the image P1. In the image DI of the dynamic phenomenon, the state of movement of the object 100 is indicated by a change in color (change in wavelength). Since the time and the wavelength are associated with each other in advance with respect to the light to be emitted, when the wavelength is specified from the image DI of the dynamic phenomenon, it is estimated at which timing and at which position the object 100 has been, and the dynamic phenomenon of the object 100 can be measured.

Returning to FIG. 1, the control apparatus 80 is a computer, and physically includes a memory such as a RAM and a ROM, a processor (arithmetic circuit) such as a CPU, a communication interface, and a storage unit such as a hard disk. The control apparatus 80 functions by executing a program stored in the memory by the CPU of the computer system. The control apparatus 80 may include a microcomputer or an FPGA.

On the basis of the imaging result obtained in the camera system 2, the control apparatus 80 calculates a wavelength (emission wavelength centroid) on the basis of the light amount of each pixel (each pixel of the image formed in the visual field) of the image that is the imaging result, and outputs the wavelength. Hereinafter, an example of a calculation principle of the emission wavelength centroid will be described in detail.

As described above, it is assumed that the inclined dichroic mirror 23 reflects all the light on the lower wavelength side than the wavelength λ₁, transmits all the light on the higher wavelength side than the wavelength λ₂, and linearly changes the transmittance of the light according to the wavelength in the wavelength band of the wavelengths λ₁ to λ₂. In this case, in relation to the wavelengths λ₁ and λ₂, the transmittance h(λ) is expressed by the following Formula (1), and the reflectance 1−h(λ) is expressed by the following Formula (2).

$$h ( λ ) = ( λ - {λ}_{1} ) / ( {λ}_{2} - {λ}_{1} ) \qquad ( 1 )$$

$$1 - h ( λ ) = ( {λ}_{2} - λ ) / ( {λ}_{2} - {λ}_{1} ) \qquad ( 2 )$$

In addition, it is obvious that the wavelength λ_{50%} at which the reflectance is 50% is expressed by the following Formula (3).

$${λ}_{50 \%} = ( {λ}_{2} + {λ}_{1} ) / 2 \qquad ( 3 )$$

When a certain emission spectrum f(λ) is between λ₁ and λ₂ and can be ignored at a wavelength shorter than λ₁ and a wavelength longer than λ₂ (for example, a case where the wavelength band of the emission spectrum f(λ) is limited by a band pass filter (not illustrated) or the like), the following Formula (4) holds on the assumption that the amount of reflected light and the amount of transmitted light are equal to each other.

$$\int f ( λ ) h ( λ ) d λ = \int f ( λ ) ( 1 - h ( λ ) ) d λ \qquad ( 4 )$$

If Formula (4) is transformed, then the following Formula (5) is obtained:

$$2 \int f ( λ ) h ( λ ) d λ = \int f ( λ ) d λ \qquad ( 5 )$$

If Formula (1) is substituted into Formula (5), then

$$2 \int f ( λ ) ( λ - {λ}_{1} ) / ( {λ}_{2} - {λ}_{1} ) d λ = \int f ( λ ) d λ$$

Further, if both sides are divided by 2∫f(λ)dλ/(λ₂−λ₁), the following formula is obtained:

$$\int f ( λ ) ( λ - {λ}_{1} ) d λ / \int f ( λ ) d λ = ( {λ}_{2} - {λ}_{1} ) / 2 \qquad ( 6 )$$

$$\int f ( λ ) λ d λ / \int f ( λ ) d λ = ( {λ}_{2} + {λ}_{1} ) / 2$$

In consideration of the Formula (3), it is clear that the right side of the Formula (6) is λ_{50%}, and the left side generally becomes the centroid of f(λ) which is an arbitrary function. The left side of the above Formula (6) is λ_{f}. From the above, when the amount of transmitted light is equal to the amount of reflected light for a certain spectrum passing through the dichroic mirror in which the transmittance is linearly inclined with respect to the wavelength, the spectral centroid λ_{f} is indicated by λ_{50%}.

Next, a second emission spectrum g(λ) is considered. As for the emission spectrum g(λ), the spectrum is also entirely included between λ₁ and λ₂. Now, for the emission spectra f(λ) and g(λ), the normalized difference between the transmitted light and the reflected light is calculated. It is assumed that as for f(λ), the transmitted light is T_{f}, the reflected light is R_{f}, the total light amount be A_{f}, and the difference between the transmitted light and the reflected light is D_{f}. Further, it is assumed that as for g(λ), the transmitted light is T_{g}, the reflected light is Re, the total light amount be A_{g}, and the difference between the transmitted light and the reflected light is D_{g}. In addition, the centroid g(λ) is defined as λ_{g}. At this time, T_{f}, R_{f}, T_{g}, and R_{g} are measurement values, and A_{f}, A_{g}, D_{f}, and D_{g} are values that can be directly calculated from the measurement values. Each of these values is also indicated by the following formulas.

$${T}_{f} = \int f ( λ ) h ( λ ) d λ = \int f ( λ ) ( λ - {λ}_{1} ) / ( {λ}_{2} - {λ}_{1} ) d λ \qquad ( 7 )$$

$${T}_{g} = \int g ( λ ) h ( λ ) d λ = \int g ( λ ) ( λ - {λ}_{1} ) / ( {λ}_{2} - {λ}_{1} ) d λ \qquad ( 8 )$$

$${R}_{f} = \int f ( λ ) ( 1 - h ( λ ) ) d λ = \int f ( λ ) ( {λ}_{2} - λ ) / ( {λ}_{2} - {λ}_{1} ) d λ \qquad ( 9 )$$

$${R}_{g} = \int g ( λ ) ( 1 - h ( λ ) ) d λ = \int g ( λ ) ( {λ}_{2} - λ ) / ( {λ}_{2} - {λ}_{1} ) d λ \qquad ( 10 )$$

$${A}_{f} = \int f ( λ ) d λ \qquad ( 11 )$$

$${A}_{g} = \int g ( λ ) d λ \qquad ( 12 )$$

$${D}_{f} = {T}_{f} - {R}_{f} = 2 / ( {λ}_{2} - {λ}_{1} ) * \int λ f ( λ ) d λ - ( {λ}_{2} + {λ}_{1} ) / ( {λ}_{2} - {λ}_{1} ) * \int f ( λ ) d λ \qquad ( 13 )$$

$${D}_{g} = {T}_{g} - {R}_{g} = 2 / ( {λ}_{2} - {λ}_{1} ) * \int λ g ( λ ) d λ - ( {λ}_{2} + {λ}_{1} ) / ( {λ}_{2} - {λ}_{1} ) * \int g ( λ ) d λ \qquad ( 14 )$$

Here, normalizing the difference between the transmitted light and the reflected light corresponds to dividing D_{f} by A_{f} and D_{g} by A_{g}. If a difference therebetween is denoted by R, the following Formula (15) is established.

$$R = {D}_{g} / {A}_{g} - {D}_{f} / {A}_{f} = \{ \int g ( λ ) λ d λ / \int g ( λ ) d λ - \int f ( λ ) λ d λ / \int f ( λ ) d λ \} * 2 / ( {λ}_{2} - {λ}_{1} ) = 2 ( {λ}_{g} - {λ}_{f} ) / ( {λ}_{2} - {λ}_{1} ) \qquad ( 15 )$$

If a difference between the wavelength centroid λ_{f} of the emission spectrum f(λ) and the wavelength centroid λ_{g} of the emission spectrum g(λ) is δλ, the following Formulas (16) and (17) are established.

$$R = 2 δλ / ( {λ}_{2} - {λ}_{1} ) \qquad ( 16 )$$

$$δλ = R ( {λ}_{2} - {λ}_{1} ) / 2 \qquad ( 17 )$$

As described above, it is shown that the difference between the centroids of two arbitrary spectra f(λ) and g(λ) can be obtained from calculation in consideration of the amount of transmitted light and the amount of reflected light.

When the centroid of f(λ) is λ_{50%}, the amount of reflected light and the amount of transmitted light are equal, and thus D_{f} is 0. That is, the wavelength centroid λ_{g} of an arbitrary spectrum g(λ) is expressed by the following Formula (18).

$${λ}_{g} = δ λ + {λ}_{50 \%} \qquad ( 18 )$$

As described above, the centroid of the emission spectrum can be calculated from the design value of the filter, the amount of transmitted light, and the amount of reflected light. Based on the above principle, the wavelength (emission wavelength centroid) of the light incident on each pixel can be obtained with high accuracy. Then, by specifying the wavelength of the light incident on each pixel, it is possible to estimate at which timing and at which position the object 100 has been, and to measure the dynamic phenomenon of the object 100, as described above.

Next, functions and effects of the present embodiment will be described.

The high-speed object measurement apparatus 1 according to the present embodiment includes the light irradiation unit 10 configured to irradiate the moving object 100 with light whose wavelength changes with time, the image capturing unit 20 configured to capture an image of light from the object 100 that has received light emitted by the light irradiation unit 10 and acquire wavelength information for each pixel, in which the image capturing unit 20 continuously acquires a temporal change of a wavelength.

In the high-speed object measurement apparatus 1 according to the present embodiment, light whose wavelength changes with time irradiates the moving object 100, light from the object is imaged, and wavelength information is acquired for each pixel. Then, in the high-speed object measurement apparatus 1, with respect to the light whose wavelength changes with time, the wavelength information is directly acquired for each pixel without being detected after being spatially separated, for example, and thus, the temporal wavelength change is continuously acquired without being discrete. As a result, it is possible to estimate at which timing and at which position the object 100 has been, with high accuracy, on the basis of the change in the acquired wavelength information. As described above, according to the high-speed object measurement apparatus 1 according to the present embodiment, the dynamic phenomenon of the object 100 can be measured with high accuracy.

Note that, also in the method of spatially separating the light whose wavelength changes with time and causing the separated light to enter different positions on the light receiving surface of the imaging unit, for example, it is conceivable to prevent the temporal wavelength change from being discrete as much as possible by finely separating time (that is, wavelength). However, in such a method, as the time is more finely separated, the light receiving area of the imaging unit is more required, and thus, there are problems that the number of frames is limited and then the visual field is narrowed, and the number of pixels of the image is reduced. That is, there is a trade-off relationship between increasing the temporal separation number to measure the dynamic phenomenon of the object with high accuracy and decreasing the light receiving area, and it has been conventionally difficult to achieve both. In this regard, as described above, according to the high-speed object measurement apparatus 1 according to the present embodiment, the light whose wavelength changes with time is not spatially separated and detected, but the wavelength information is directly acquired for each pixel. Therefore, it is possible to measure the dynamic phenomenon of the object 100 with high accuracy without causing the problem due to the light receiving area described above.

The light irradiation unit 10 may emit light whose wavelength changes in a cycle of one cycle or more within an exposure time of the image capturing unit 20. According to such a configuration, it is possible to measure (store) the dynamic phenomenon of the object 100 with the time width of the light whose wavelength changes with time in one frame of the image capturing unit.

The light irradiation unit 10 may be arranged such that an optical axis of light directed from the light irradiation unit 10 toward the object 100 and an optical axis of light directed from the object 100 toward the image capturing unit 20 are orthogonal to each other. According to such a configuration, for example, in a case where the object 100 moves in the same direction as the optical axis direction of the light directed from the light irradiation unit 10 toward the object 100, a certain point (for example, an edge portion) of the object 100 is irradiated with light, and the change in wavelength with the lapse of time of the light from the certain point can be detected by pixels mutually different in the image capturing unit 20. That is, it is possible to measure the dynamic phenomenon of the object 100 with high accuracy based on the detection result of each pixel while avoiding light from entering the same pixel a plurality of times.

The light irradiation unit 10 may include a white light source, and may change a wavelength with time by optically selecting a wavelength of white light. According to such a configuration, light whose wavelength changes with time can be generated with a simple configuration.

The light irradiation unit 10 may include a pulsed light source, and may change a wavelength with time by wavelength-dispersing pulsed light. According to such a configuration, light whose wavelength changes with time can be generated with a simple configuration.

The image capturing unit 20 may include the inclined dichroic mirror 23 that separates light from the object 100 by transmitting or reflecting the light according to a wavelength, having an edge transition width with a predetermined width, which is a width of a wavelength band in which transmittance and reflectance change according to a change in wavelength, and may image light transmitted through the inclined dichroic mirror 23 in a first imaging region and light reflected by the inclined dichroic mirror 23 in a second imaging region. According to such a configuration, each of the light beams separated by the inclined dichroic mirror 23 whose transmittance and reflectance change according to the change in wavelength is imaged, and the wavelength can be appropriately detected on the basis of the respective imaging results.

Although the embodiments of the present invention have been described above, the present invention is not limited to the above embodiments. Hereinafter, first to third modifications will be described as aspects different from the above embodiment.

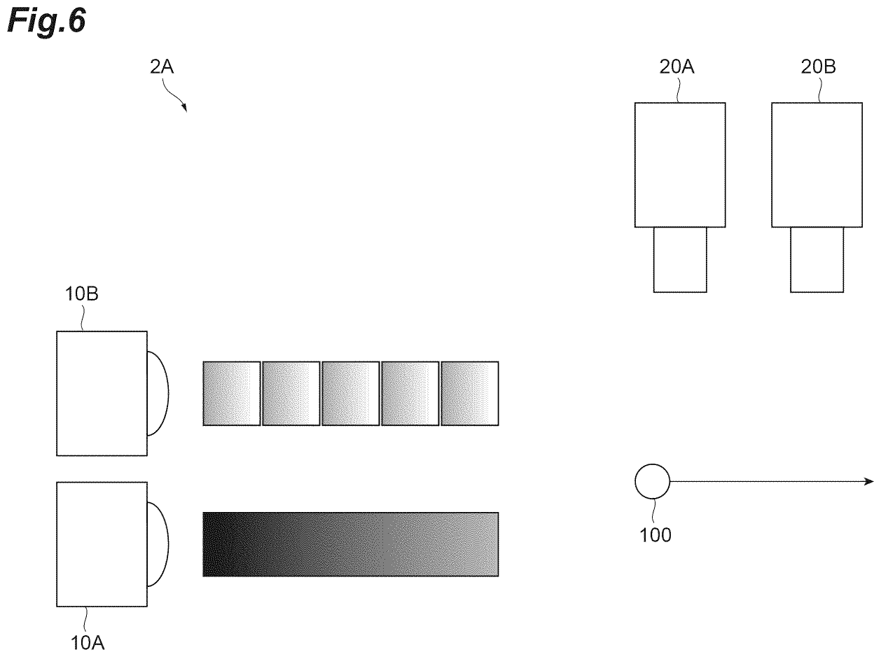

FIG. 6 is a diagram schematically illustrating a camera system 2A of the high-speed object measurement apparatus according to a first modification. The camera system 2A includes two light irradiation units, a first irradiation unit 10A and a second irradiation unit 10B. The first irradiation unit 10A emits light in the first wavelength range in a cycle in which wavelength changes as a first cycle. The second irradiation unit 10B emits light in a second wavelength range different from the first wavelength range in a cycle in which wavelength changes as a second cycle different from the first cycle. Specifically, for example, the first irradiation unit 10A emits light in a wavelength range of 600 nm to 700 nm in a cycle in which the wavelength changes as the first cycle. The second irradiation unit 10B emits light in a wavelength range of, for example, 400 nm to 500 nm in a cycle in which the wavelength changes as the second cycle. As described above, the first cycle and the second cycle are different from each other. For example, the first cycle and the second cycle may be set such that while the first irradiation unit 10A scans light in the wavelength range of 600 nm to 700 nm once in one exposure time, the second irradiation unit 10B scans light in the wavelength range of 400 nm to 500 nm ten times in one exposure time. Note that such a cycle is an example, and each cycle is not limited to the above as long as the first cycle and the second cycle are different from each other.

The camera system 2A illustrated in FIG. 6 includes two image capturing units, that is, a first camera 20A and a second camera 20B. The first camera 20A captures an image of light from the object 100 that has received the light emitted by the first irradiation unit 10A. The second camera 20B captures an image of light from the object 100 that has received the light emitted by the second irradiation unit 10B. The first camera 20A and the second camera 20B image light in a wavelength range not overlapping each other. That is, the first camera 20A captures an image of the light emitted by the first irradiation unit 10A, that is, the light having a wavelength range of 600 nm to 700 nm. The first camera 20A may be set with a bandpass filter so as not to capture light outside the wavelength range described above. The second camera 20B captures an image of the light emitted by the second irradiation unit 10B, that is, the light having a wavelength range of 400 nm to 500 nm. The second camera 20B may be set with a bandpass filter so as not to capture light outside the wavelength range described above.

Such a configuration is a configuration for improving the time resolution in the measurement of the dynamic phenomenon of the object 100. For example, in a configuration in which there is one light irradiation unit and one image capturing unit, the resolution is about 1/100 in one frame due to the size of the full well of the camera, the shot noise limit, the readout noise, and the like. This is because the shot noise limit of S/N is the square root of the number of electrons in the well, and in a case where the luminance is sufficient, the readout noise is equal to or less than the shot noise and can be ignored. In addition, since the well size in the case of a camera for measurement is usually several tens of thousands of electrons, the luminance of the actual image is used at half or less thereof in order to avoid image saturation. As a measure to exceed this limit, as in the configuration illustrated in FIG. 6, by irradiating the object 100 with light having different wavelength ranges with different cycles in which the wavelengths change from each other (scanning the wavelengths at different speeds), a position at which the object has been is estimated from the information on the wavelengths of the two light beams, therefore, it is possible to improve the time resolution. For example, as described above, in a case where the second irradiation unit 10B scans light in the wavelength range of 400 nm to 500 nm ten times in one exposure time while the first irradiation unit 10A scans light in the wavelength range of 600 nm to 700 nm once in one exposure time, the time resolution can be improved to ten times as compared with a case where it is estimated from only one light beam, and the dynamic phenomenon of the object 100 can be measured with high accuracy.

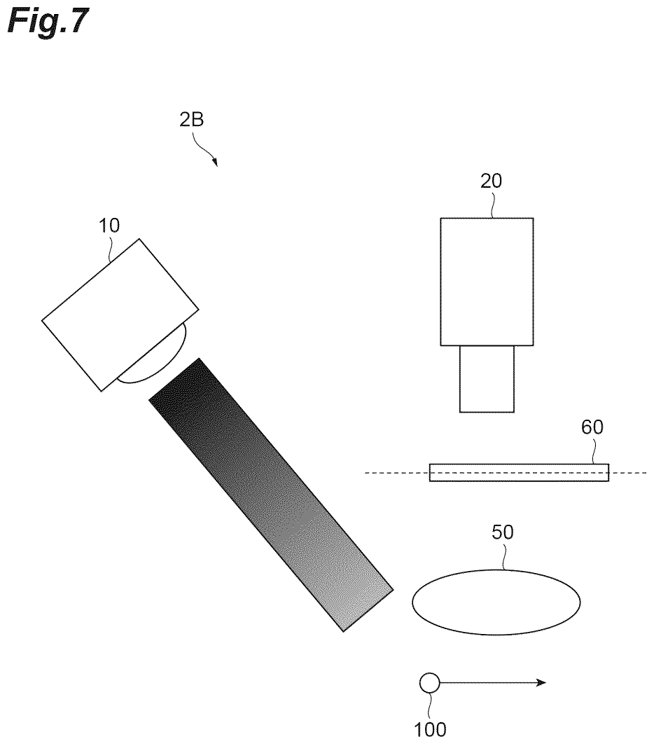

FIG. 7 is a diagram schematically illustrating a camera system 2B of the high-speed object measurement apparatus according to a second modification. The light irradiation unit 10 is arranged, in the camera system 2B, such that an optical axis of light directed from the light irradiation unit 10 toward the object 100 (a first optical axis) and an optical axis of light directed from the object 100 toward the image capturing unit 20 (a second optical axis) obliquely intersect with each other. The above-described state where the first optical axis and the second optical axis obliquely intersect with each other is a state where the first optical axis and the second optical axis may obliquely intersect with each other at any timing while the moving object 100 is irradiated with light. The direction of the first optical axis does not coincide with the direction in which the object 100 moves. In the example illustrated in FIG. 7, while the object 100 moves in the horizontal direction, both the light irradiation unit 10 and the image capturing unit 20 are provided above the object 100. In a case where the first optical axis and the second optical axis obliquely intersect with each other, when the surface of the moving object 100 is irradiated with light, light at different timings may enter the same pixel of the imaging element 21 of the image capturing unit 20 that images the light from the object 100. That is, light at a plurality of positions of the moving object 100 may overlap and enter the same pixel. In this case, the timing of the movement of the object 100 cannot be appropriately acquired, and there is a possibility that the dynamic phenomenon of the object 100 cannot be measured with high accuracy.

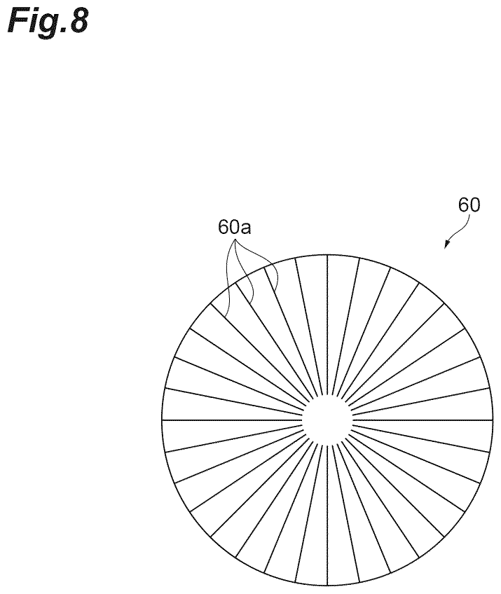

As a configuration for solving such a problem, the camera system 2B further includes a slit 60 disposed on an optical axis of light from the object 100 toward the image capturing unit 20 (second optical axis), and a lens 50 provided between the slit 60 and the object 100. The slit 60 changes a region through which light passes according to the lapse of time. FIG. 8 is a diagram schematically illustrating the slit 60 included in the camera system 2B of FIG. 7. FIG. 8 is a plan view of the slit 60. As illustrated in FIG. 8, the slit 60 has a substantially circular shape in plan view, and light passing portions 60a are formed in the slit 60 at predetermined intervals along the circumferential direction. The slit 60 rotates to change the region through which light passes according to the lapse of time. The exposure time of the image capturing unit 20 is equal to or shorter than the time during which the slit 60 rotates and advances by one step (advances to the next light passing portion 60a). Note that the rotation operation of the slit 60 and the image capturing unit 20 does not need to be synchronized. By providing the slit 60 like this, even in a case where the first optical axis and the second optical axis obliquely intersect with each other (in a case where the surface of the moving object 100 is irradiated with light), it is possible to avoid light at a plurality of timings from entering the same pixel, and it is possible to measure the dynamic phenomenon of the object 100 with high accuracy.

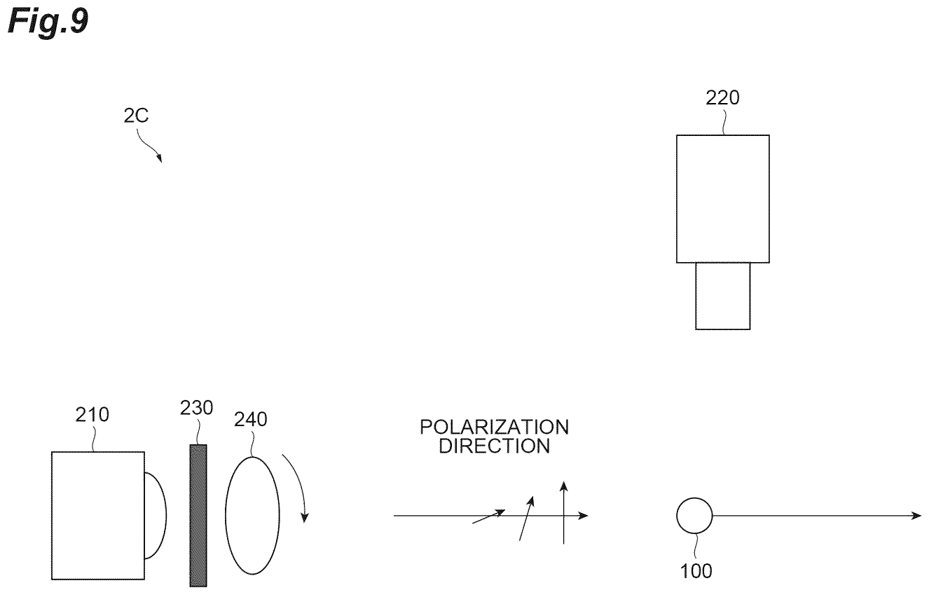

So far, an example has been described in which the moving object 100 is irradiated with light whose wavelength changes with time. However, the high-speed object measurement apparatus is not limited to such an aspect. In other words, the high-speed object measurement apparatus may include a light irradiation unit configured to irradiate the moving object 100 with light whose state of the light changes with time, an imaging unit configured to capture an image of light from the object that has received light emitted by the light irradiation unit and acquire the state of light for each pixel, in which the imaging unit may continuously acquire a temporal change of the state of light. According to such a configuration, it is possible to highly accurately estimate at which timing and at which position the object 100 has been on the basis of the acquired state of light, and to measure the dynamic phenomenon of the object 100 with high accuracy. The high-speed object measurement apparatus may include, for example, a light irradiation unit configured to irradiate the moving object 100 with light whose polarization direction changes with time, an imaging unit configured to capture an image of light from the object 100 that has received light emitted by the light irradiation unit and acquire the polarization direction for each pixel, in which the imaging unit may continuously acquire a temporal change of the polarization direction. Hereinafter, such an aspect will be described as a third modification with reference to FIG. 9.

FIG. 9 is a diagram schematically illustrating a camera system 2C of the high-speed object measurement apparatus according to a third modification. The camera system 2C includes a light source 210, a polarizer 230, and a half wave plate 240 as a configuration of a light irradiation unit. The light source 210 emits linearly polarized light. The half wave plate 240 continuously rotates in synchronization with a timing of the frame measurement start of a polarization camera 220. As a result, the polarization direction of the light applied to the object 100 changes with time. That is, it is possible to set a situation in which light is emitted in different polarization directions for each position of the moving object 100, and it is possible to specify where and at which timing of the exposure timing the object 100 has been. The camera system 2C includes the polarization camera 220 as an image capturing unit (imaging unit). The polarization camera 220 is, for example, one set for every four pixels, and polarizers different by 45° are formed in each of the four pixels. Then, the polarization camera 220 acquires which linearly polarized light or which elliptically polarized light the polarization direction of the light incident on this position is, from the light amount ratio of the four pixels. According to such a configuration, it is possible to estimate with high accuracy at which timing and at which position the object 100 has been on the basis of the detected polarization direction, and to measure the dynamic phenomenon of the object 100 with high accuracy. In addition to the rotation of the half wavelength plate, a liquid crystal element (LCOS) or a spatial light transformation element may be used for the rotation in the polarization direction, or the Faraday effect may be used to change the strength of the magnetic field applied to the Faraday element through which illumination is transmitted.

### REFERENCE SIGNS LIST

1 high-speed object measurement apparatus (measurement apparatus)
10 light irradiation unit
11 pulsed light source
20 Image capturing unit (imaging unit)
23 inclined dichroic mirror (separation optical element)
60 slit
100 subject

1. A measurement apparatus comprising:
a light irradiator configured to irradiate a moving object with light whose wavelength changes with time;
an imaging unit configured to capture an image of light from the object that has received light emitted by the light irradiator and acquire wavelength information for each pixel, wherein
the imaging unit continuously acquires a temporal change of a wavelength.

2. The measurement apparatus according to claim 1, wherein the light irradiator emits light whose wavelength changes in a cycle of one cycle or more within an exposure time of the imaging unit.

3. The measurement apparatus according to claim 1, wherein the light irradiator is arranged such that an optical axis of light directed from the light irradiator toward the object and an optical axis of light directed from the object toward the imaging unit are orthogonal to each other.

4. The measurement apparatus according to claim 1, wherein
the light irradiator is arranged such that an optical axis of light directed from the light irradiator toward the object and an optical axis of light directed from the object toward the imaging unit obliquely intersect with each other,
the measurement apparatus further comprises a slit arranged on an optical axis of light directed from the object toward the imaging unit, and
the slit changes a region through which light passes according to a lapse of time.

5. The measurement apparatus according to claim 1, wherein
the light irradiator comprises:
a first irradiator configured to emit light in a first wavelength range whose wavelength changes in a cycle as a first cycle; and
a second irradiator configured to emit light in a second wavelength range different from the first wavelength range whose wavelength changes in a cycle as a second cycle different from the first cycle.

6. The measurement apparatus according to claim 5, wherein
the imaging unit comprises:
a first camera configured to capture an image of light from the object that has received light emitted by the first irradiator; and
a second camera configured to captures an image of light from the object that has received light emitted by the second irradiator.

7. The measurement apparatus according to claim 1, wherein the light irradiator comprises a white light source, and changes a wavelength with time by optically selecting a wavelength of white light.

8. The measurement apparatus according to claim 1, wherein the light irradiator comprises a pulsed light source, and changes a wavelength with time by wavelength-dispersing pulsed light.

9. The measurement apparatus according to claim 1, wherein
the imaging unit
comprises a separation optical element that separates light from the object by transmitting or reflecting the light according to a wavelength, having an edge transition width with a predetermined width, which is a width of a wavelength band in which transmittance and reflectance change according to a change in wavelength, and
images light transmitted through the separation optical element in a first imaging region and light reflected by the separation optical element in a second imaging region.

10. A measurement method comprising the steps of:
irradiating a moving object with light whose wavelength changes with time;
capturing an image of light from the object that has received light and acquiring wavelength information for each pixel, wherein
the step of acquiring the wavelength information continuously acquires a temporal change of a wavelength.
